(19) United States
(12) Patent Application Publication
(10) Pub. No.: US 2014/0376235 A1
(43) Pub. Date: Dec. 25, 2014

(54) LENS WITH DIFFERENT LAYERS AND METHOD MAKING THE SAME

(71) Applicant: HON HAI PRECISION INDUSTRY CO., LTD., New Taipei (TW)

(72) Inventors: FENG-YUEN DAI, Tu-Cheng (TW); CHAU-JIN HU, Tu-Cheng (TW); YUNG-LUN HUANG, Tu-Cheng (TW); LI-YING WANG HE, Tu-Cheng (TW)

(73) Assignee: HON HAI PRECISION INDUSTRY CO., LTD., New Taipei (TW)

(21) Appl. No.: 14/014,411

(22) Filed: Aug. 30, 2013

(30) Foreign Application Priority Data
Jun. 25, 2013 (TW) 102122609

(51) Int. Cl. F21V 5/04; B32B 37/14

(52) U.S. Cl. CPC F21V 5/04; B32B 37/14; B32B 2307/418
USPC 362/335; 156/60

(57) ABSTRACT

A lens includes a first optical layer, a second optical layer and a third optical layer sequentially stacked. The third optical layer has a light refractive index larger than that of the second optical layer, and the second optical layer has a light refractive layer larger than that of the first optical layer. A method for making the lens is also provided.

### BACKGROUND

1. Technical Field

The disclosure generally relates to lenses, and more particularly to a lens having different layers and a method for making the lens.

2. Description of Related Art

Nowadays LEDs (light emitting diodes) are applied widely in various applications for illumination. The LED is a highly pointed light source. Thus, light directly emitted from the LED may form a small light spot. The small light spot can only illuminate a small area. Thus, in order to achieve a large illumination area, a large number of LEDs are required to be used, thereby increasing the illumination cost.

What is needed, therefore, is a lens having different layers and a method for making the lens which can address the limitations described.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the various views.

FIG. 1 shows a lens in accordance with an embodiment of the present disclosure.

FIG. 2 shows a cross section of the lens of FIG. 1 taken along line II-II thereof, wherein a light emitting diode is placed below the lens.

### DETAILED DESCRIPTION

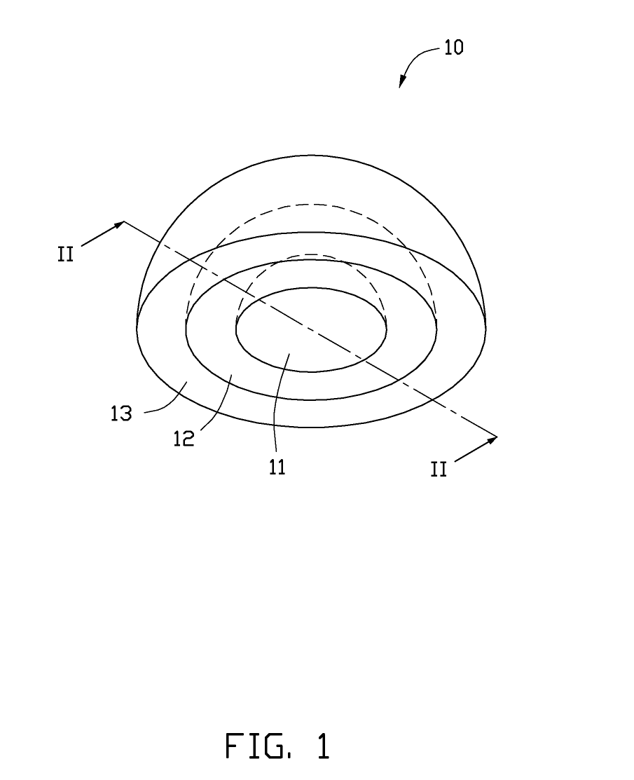

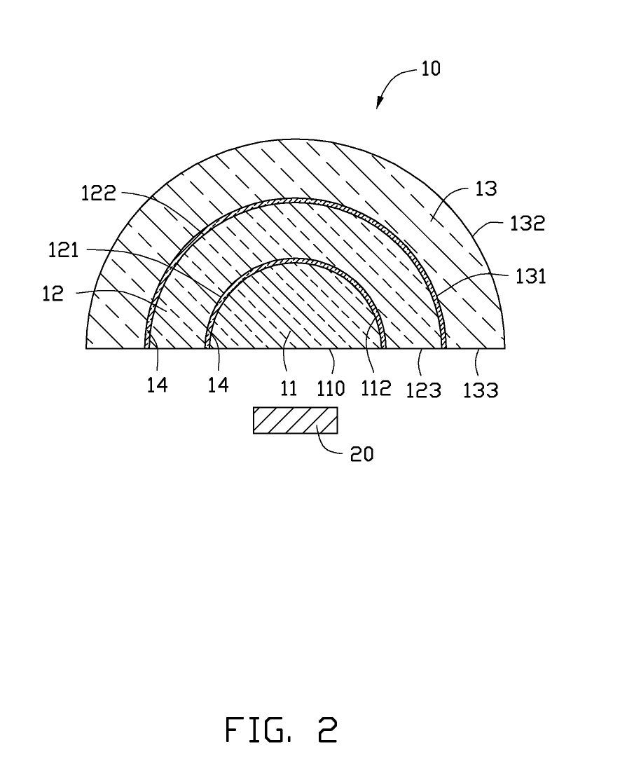

Referring to FIGS. 1-2, a lens 10 in accordance with an embodiment of the present disclosure is shown. The lens 10 is used for modulating light emitted from a light emitting diode 20.

The lens 10 includes a first optical layer 11, a second optical layer 12 and a third optical layer 13 sequentially stacked. The first optical layer 11 is solid and has a semispherical shape. The first optical layer 11 has a flat bottom face 110 and a semispherical top face 112 connecting the bottom face 110. The bottom face 110 of the first optical layer 11 acts as a light incident face of the first optical layer 11, and the top face 112 of the first optical layer 11 acts as a light emerging face of the first optical layer 11. Light emitted from the light emitting diode 20 can enter the first optical layer 11 through the bottom face 110 and exit the first optical layer 11 through the top face 112.

The second optical layer 12 covers the first optical layer 11. The second optical layer 12 includes an inner face 121, an outer face 122 opposite to the inner face 121 and an annular bottom face 123 connecting the inner face 121 with the outer face 122. The inner face 121 and the outer face 122 are both semispherical faces parallel to each other. The inner face 121 of the second optical layer 12 acts as a light incident face of the second optical layer 12, and the outer face 122 of the second optical layer 12 acts as a light emerging face of the second optical layer 12. Alternatively, the bottom face 123 of the second optical layer 12 may also act as a light incident face of the second optical layer 12 together with the inner face 121. The inner face 121 of the second optical layer 12 is also parallel to the top face 112 of the first optical layer 11. The inner face 121 of the second optical layer 12 is fixed to the top face 112 of the first optical layer 11 by a first adhesive layer 14. A thickness of the first adhesive layer 14 may be 10 nm. The first adhesive layer 14 is transparent for allowing the light to pass therethrough. The second optical layer 12 has a light refractive index less than that of the first optical layer 11. Thus, the light emitted from the first optical layer 11 can be diverged at an interface between the top face 112 of the first optical layer 11 and the inner face 121 of the second optical layer 12. The diverged light further transmits out of the second optical layer 12 through the outer face 122 of the second optical layer 12.

The third optical layer 13 covers the second optical layer 12. The third optical layer 13 includes an inner face 131, an outer face 132 opposite to the inner face 131 and an annular bottom face 133 connecting the inner face 131 with the outer face 132. The inner face 131 and the outer face 132 are both semispherical faces parallel to each other. The bottom faces 110, 123, 133 of the first optical layer 11, the second optical layer 12 and the third optical layer 13 are coplanar with each other. The inner face 131 of the third optical layer 13 acts as a light incident face of the third optical layer 13, and the outer face 132 of the third optical layer 13 acts as a light emerging face of the third optical layer 13. Alternatively, the bottom face 133 of the third optical layer 13 may also act as a light incident face of the third optical layer 13 together with the inner face 131. The inner face 131 of the third optical layer 13 is also parallel to the outer face 122 of the second optical layer 12. The inner face 131 of the third optical layer 13 is fixed to the outer face 122 of the second optical layer 12 by a second adhesive layer 14. A thickness of the second adhesive layer 14 may also be 10 nm. The second adhesive layer 14 is also transparent for allowing the light to pass therethrough. The third optical layer 13 has a light refractive index less than that of the second optical layer 12. Thus, the diverged light emitted from the second optical layer 12 can be further diverged at an interface between the outer face 122 of the second optical layer 12 and the inner face 131 of the third optical layer 13. The further diverged light transmits out of the third optical layer 13 through the outer face 132 of the third optical layer 13. Therefore, the light emitted from the light emitting diode 20 can be diverged by the lens 10 to have a larger illumination area. Less light emitting diodes 20 are required to illuminate a large area when use with the lenses 10, thereby decreasing an illumination cost. The lens 10 is particularly suitable for use in a backlight module for illuminating a display.

The first optical layer 11, the second optical layer 12 and the third optical layer 13 may be made of transparent polymer including different numbers of benzene rings, such as methyl methacrylate. Thus, the first optical layer 11, the second optical layer 12 and the third optical layer 13 can have different refractive index.

A method for manufacturing the lens is also disclosed. Firstly, the first optical layer 11, the second optical layer 12 and the third optical layer 13 are provided. The first optical layer 11 is then adhered to the second optical layer 12 by a first adhesive layer 14, and the second optical layer 12 is adhered to the third optical layer 13 by a second adhesive layer 14. Finally, the first adhesive layer 14 and the second adhesive layer 14 are cured by ultraviolet light, thereby fixing the first optical layer 11, the second optical layer 12 and the third optical layer 13 together.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A lens comprising:
a first optical layer comprising a first light incident face and a first light emerging face opposite to the first light incident face; and
a second optical layer covering the first optical layer, the second optical layer comprising a second light incident face confronting the first light emerging face of the first optical layer, and a second light emerging face opposite to the second light incident face;
wherein the second optical layer has a light refractive index less than that of the first optical layer.

2. The lens of claim 1, wherein the second incident face is indirectly connected to the first light emerging face by an adhesive layer.

3. The lens of claim 2, wherein the adhesive layer is sandwiched between the first optical layer and the second optical layer.

4. The lens of claim 1, wherein the first light incident face comprises a flat bottom face of the first optical layer.

5. The lens of claim 4, wherein the first light emerging face comprises a semispherical top face of the first optical layer.

6. The lens of claim 4, wherein the second light incident face comprises a semispherical inner face of the second optical layer.

7. The lens of claim 6, wherein the second light emerging face comprises a semispherical outer face of the second optical layer.

8. The lens of claim 7, wherein the second light incident face comprises an annular bottom face interconnecting the inner face and the outer face.

9. The lens of claim 8 further comprising a third optical layer covering the second optical layer, wherein the third optical layer has a light refractive index less than that of the second optical layer.

10. The lens of claim 9, wherein the third optical layer comprising a third light incident face confronting the second light emerging face of the second optical layer, and a third light emerging face opposite to the third light incident face.

11. The lens of claim 10, wherein the third light incident face is indirectly connected to the second light emerging face by an adhesive layer.

12. The lens of claim 10, wherein the third optical layer further comprises a bottom face interconnecting the third incident face and the third light emerging face, the bottom faces of the first optical layer, the second optical layer and the third optical layer are coplanar with each other.

13. The lens of claim 10, wherein the first light emerging face, the second light incident face, the second light emerging face, the third light incident face and the third light emerging face are parallel to each other.

14. The lens of claim 1, wherein the first optical layer and the second optical layer are made of transparent material with different numbers of benzene rings.

15. A method for making a lens, comprising:
providing a first optical layer and a second optical layer, the second optical layer having a light refractive index less than that of the first optical layer;
adhering the first optical layer with the second optical layer via an adhesive layer.

16. The method of claim 15, wherein the first optical layer comprises a first light incident face and a first light emerging face, and the second optical layer comprises a second light incident face adhered to the first light emerging face via the adhesive layer and a second light emerging face.

17. The method of claim 16, wherein the first light incident face is a flat face, the first light emerging face, the second light incident face and the second light emerging face are semispherical faces parallel to each other.

18. The method of claim 17, wherein the second optical layer comprises a bottom face interconnecting the second light incident face and the second light emerging face, the bottom face being coplanar with the first light incident face.

19. The method of claim 15, wherein the second optical layer is covered by a third optical layer, the third optical layer having a light refractive index less than that of the second optical layer.

20. The method of claim 15, wherein the first optical layer and the second optical layer are made of transparent polymer with different numbers of benzene rings.
